(19) United States
(12) Patent Application Publication
(10) Pub. No.: US 2025/0353601 A1
(43) Pub. Date: Nov. 20, 2025

(54) FUEL CELL COOLING AND WASTE HEAT RECOVERY SYSTEM FOR GENERATING POWER FOR AIRCRAFT SYSTEMS

(71) Applicant: Hamilton Sundstrand Corporation, Charlotte, NC (US)

(72) Inventors: Viktor Kilchyk, Lancaster, NY (US); Debabrata Pal, Hoffman Estates, IL (US)

(21) Appl. No.: 18/664,992

(22) Filed: May 15, 2024

(51) Int. Cl. B64D 13/08; B64D 13/06; H01M 8/04007; H01M 8/04029; H01M 8/04119

(52) U.S. Cl. CPC B64D 13/08; H01M 8/04029; H01M 8/04067; H01M 8/04134; H01M 8/04164; B64D 2013/0618; B64D 2013/0644; B64D 2013/0648; B64D 2013/0662; H01M 2250/20

(57) ABSTRACT

A system that provides a cooling liquid to a component of an aircraft, the system having: a cooling circuit that includes a fuel cell that receives a first flow and transfers first waste heat to the first flow; an air cycle machine (ACM) that transfers second waste heat to a second flow; a first heat exchanger, fluidly coupled to the cooling circuit downstream of the fuel cell, that thermally couples the first and second flows to superheat the first flow; a turbine, fluidly coupled to the cooling circuit downstream of the first heat exchanger, that extracts energy from the first flow; and a condenser, fluidly coupled to the cooling circuit downstream of the turbine, that condenses the first flow into the cooling liquid, wherein the component is fluidly coupled to the circuit downstream of the condenser.

### BACKGROUND

The embodiments are directed to power systems for aircrafts and more specifically to a fuel cell cooling and waste heat recovery system for generating power for aircraft systems.

A fuel cell may reject up to half of its total available energy in the form of low-value heat. A large portion of the heat rejection is in the form of latent heat of vaporization. Capturing fuel cell heat values requires two-phase wet air expansion. An air cycle machine (ACM) also rejects heat, and an amount of rejected heat may be a few times larger than an amount of its cooling capacity. The rejected heat results in inefficient operation of components of an aircraft that may be powered by a fuel cell or may utilize an ACM.

### BRIEF DESCRIPTION

Disclosed is a system that provides a cooling liquid to a component of an aircraft, the system including: a cooling circuit that includes a fuel cell that receives a first flow and transfers first waste heat to the first flow; an air cycle machine (ACM) that transfers second waste heat to a second flow; a first heat exchanger, fluidly coupled to the cooling circuit downstream of the fuel cell, that thermally couples the first and second flows to superheat the first flow; a turbine, fluidly coupled to the cooling circuit downstream of the first heat exchanger, that extracts energy from the first flow; and a condenser, fluidly coupled to the cooling circuit downstream of the turbine, that condenses the first flow into the cooling liquid, wherein the component is fluidly coupled to the circuit downstream of the condenser.

In addition to one or more aspects of the system, or as an alternate, the condenser is a RAM air condenser.

In addition to one or more aspects of the system, or as an alternate, the turbine is a flash turbine or an impulse turbine.

In addition to one or more aspects of the system, or as an alternate, the system includes a water separator, fluidly coupled to the cooling circuit between the condenser and the component, that separates the first flow into the cooling liquid and vapor and directs the vapor to an exhaust.

In addition to one or more aspects of the system, or as an alternate, the system includes a motor generator, operationally coupled to the turbine, and fluidly coupled to the water separator, wherein: a first portion of the cooling liquid is directed to the motor generator, and third waste heat is transferred to the cooling liquid within the motor generator; and the cooling liquid is directed from the motor generator to the first flow, between the fuel cell and the first heat exchanger.

In addition to one or more aspects of the system, or as an alternate, the system includes a compressor, coupled to the motor generator.

In addition to one or more aspects of the system, or as an alternate: the compressor is fluidly coupled to the cooling circuit upstream of the fuel cell; and the compressor receives the first flow, compresses the first flow and directs the first flow to the fuel cell.

In addition to one or more aspects of the system, or as an alternate, a second portion of the cooling liquid is directed to the first flow, between the compressor and the fuel cell, to thereby raise a humidity level of the first flow entering the fuel cell.

In addition to one or more aspects of the system, or as an alternate, the system includes a pump, coupled to the motor generator and fluidly coupled to the cooling circuit between the water separator and the fuel cell, wherein a second portion of the cooling liquid is directed to the pump.

In addition to one or more aspects of the system, or as an alternate, the system includes an air vent fluidly coupled to the cooling circuit between the pump and the fuel cell.

In addition to one or more aspects of the system, or as an alternate, the system includes a cabin air compressor, coupled to the motor generator.

A system that provides a cooling liquid to a component of an aircraft, the system including: a cooling circuit that includes a fuel cell that receives a first flow and transfers first waste heat to the first flow; a condenser, fluidly coupled to the cooling circuit downstream of the fuel cell, that condenses the first flow into the cooling liquid, wherein the component is fluidly coupled to the circuit downstream of the condenser.

In addition to one or more aspects of the system, or as an alternate, the system includes a water separator, fluidly coupled to the cooling circuit between the condenser and the component, that separates the first flow into the cooling liquid and vapor and directs the vapor to an exhaust.

In addition to one or more aspects of the system, or as an alternate, the system includes an air cycle machine, fluidly coupled to the cooling circuit upstream of the fuel cell that directs the first flow to the fuel cell.

In addition to one or more aspects of the system, or as an alternate, a first portion of the cooling liquid is directed to the first flow, between the ACM and the fuel cell, to thereby raise a humidity level of the first flow entering the fuel cell.

In addition to one or more aspects of the system, or as an alternate, the system includes a pump, fluidly coupled to the cooling circuit between the condenser and the fuel cell, and a fluid storage tank fluidly coupled to the cooling circuit between the condenser and the pump, wherein the first flow includes a first portion of the cooling liquid and fluid from the storage tank that are pumped to the fuel cell via the pump.

Further disclosed is another system that generates power for an aircraft, the system including: a first circuit that includes a fuel cell that receives a first flow and transfers first waste heat to the first flow; an air cycle machine that transfers second waste heat to a second flow; a first heat exchanger, fluidly coupled to the first circuit downstream of the fuel cell, that thermally couples the first and second flows to superheat the first flow; a first pump, fluidly coupled to the first circuit downstream of the first heat exchanger, to pump the first flow through the first circuit; and a second circuit that is a cogeneration refrigeration (CR) circuit with a third flow flowing through the second circuit, and the second circuit includes a second heat exchanger that is thermally coupled to the first heat exchanger to transfer heat energy to the third flow, thereby cooling the first flow.

In addition to one or more aspects of the another system, or as an alternate, the cogeneration refrigeration circuit includes: a refrigeration loop and a power generation loop coupled to each other via a divider and a mixer, wherein: the refrigeration loop includes a first branch extending between an inlet of the divider and an outlet of the mixer, and a second branch extending between a first outlet of the divider and a first inlet of the mixer; the first branch includes an evaporator, a compressor, and a condenser, a second pump, and the second heat exchanger, and the second branch includes an expansion valve; and the power generation loop extends from a second outlet of the divider and a second inlet of the mixer, wherein the power generation loop includes at least one turbine.

In addition to one or more aspects of the another system, or as an alternate: the power generation loop includes a second turbine downstream of the first turbine; and a first control valve upstream of the first turbine and an isolation valve downstream of the second turbine.

In addition to one or more aspects of the another system, or as an alternate, the first circuit includes a humidifier fluidly coupled to the fuel cell to control a humidity level within the fuel cell.

### BRIEF DESCRIPTION OF THE DRAWINGS

The following descriptions should not be considered limiting in any way. With reference to the accompanying drawings, like elements are numbered alike:

FIG. 1 shows a cooling circuit that provides a cooling liquid to a component of an aircraft, where the cooling circuit includes a fuel cell and air cycle machine (ACM) that add heat to a flow of cabin air, which powers a turbine to drive a compressor, and the compressor draws the flow from the cabin;

FIG. 2 shows a cooling circuit that provides a cooling liquid to a component of an aircraft, where the cooling circuit includes a fuel cell and ACM that add heat to a flow of cabin air, which powers a turbine to drive a compressor, and the compressor is utilized for other aircraft systems;

FIG. 3 shows a cooling circuit that provides a cooling liquid to a component of an aircraft, where the cooling circuit includes a fuel cell and ACM that add heat to a cooling flow, which powers a turbine to drive a pump, and the pump is utilized to pump the cooling flow to the fuel cell;

FIG. 4 shows a cooling circuit that provides a cooling liquid to a component of an aircraft, where the cooling circuit includes a fuel cell and ACM that add heat to a cooling flow, which powers a turbine to drive a cabin air compressor, and a portion of the cooling liquid provided by the cooling circuit mixed with air to form the cooling flow utilized by the fuel cell;

FIG. 5 shows a cooling circuit that provides a cooling liquid to a component of an aircraft, where the cooling circuit includes a fuel cell that adds heat to a flow obtained in part from an ACM and cabin air, which is then cooled and condensed to provide cooling flow to aircraft components; and

FIG. 6 shows a cooling circuit that provides a cooling liquid to a component of an aircraft, where the cooling circuit includes a fuel cell that adds heat to a flow of the cooling liquid that is directed to the fuel cell via a pump, which is then cooled and condensed to provide cooling flow to aircraft components.

### DETAILED DESCRIPTION

A detailed description of one or more embodiments of the disclosed apparatus are presented herein by way of exemplification and not limitation with reference to the Figures.

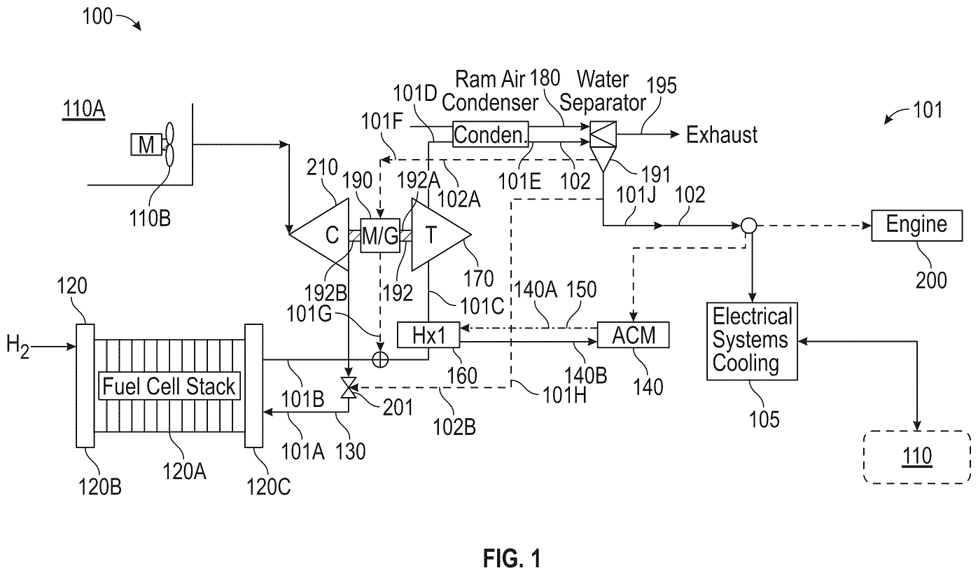

Turning to FIG. 1, a system 100 is disclosed that provides a cooling liquid flow (or for simplicity a cooling liquid) 102 to a component 105 of an aircraft 110, shown schematically.

The system 100 includes a cooling circuit 101. The cooling circuit 101 includes a fuel cell 120. The fuel cell 120 may have a stack 120A of cells, an anode 120B and cathode 120C. The fuel cell 120 receives a first flow 130, which may be air, and transfers first waste heat to the first flow 130. A first conduit 101A may direct the first flow 130 to the fuel cell 120 and a second conduit 101B may direct the first flow 130, downstream, from the fuel cell 120. Upon leaving the fuel cell 12, the first flow 130 may be steam mixed with air.

The system 100 includes an air cycle machine (ACM) 140. The ACM 140 transfers second waste heat to a second flow 150.

A first heat exchanger 160 is fluidly coupled to the cooling circuit 101 and is located downstream of the fuel cell 120. The second conduit 101B may extend between the fuel cell 120 and the first heat exchanger 160 and transport the first flow 130 to the first heat exchanger 160. The first heat exchanger 160 thermally couples the first and second flows 130, 150 to superheat the first flow 130. The first flow 130 may be a relatively hot two-phase flow upon exiting the first heat exchanger 160.

The first heat exchanger 160 may be coupled to the ACM 140 via first and second ACM conduits 140A, 140B. The first ACM conduit 140A may transport the second flow 150 to the first heat exchanger 160 and the second ACM conduit 140B may transport the second flow 150 back to the ACM 140.

A turbine 170 is fluidly coupled to the cooling circuit 101 and located downstream of the first heat exchanger 160, and extracts energy from the first flow 130. A third conduit 101C may extend between first heat exchanger 160 and the turbine 170 to transport the first flow 130 to the turbine 170. The turbine 170 may be a flash turbine, which is capable of extracting power from two phase flow. The turbine 170 may alternatively be an impulse turbine, as a non-limiting example.

A condenser 180 is fluidly coupled to the cooling circuit 101 downstream of the turbine 170. The condenser 180 may be a RAM air condenser. A fourth conduit 101D may extend between the turbine 170 and the condenser 180 to transport the first flow 130 to the condenser 180. As indicated, at this location in the circuit the first flow 130 is stream mixed with air. The condenser 180 condenses the first flow 130 into the cooling liquid 102. The first flow 130 may be a relatively cool two phase flow upon leaving the condenser 180. As shown in FIG. 1, the component 105 is fluidly coupled to the circuit 101, downstream of the condenser 180.

As further shown in FIG. 1, a water separator 191 is fluidly coupled to the cooling circuit 101 and located between the condenser 180 and the component 105. A fifth conduit 101E may extend between the condenser 180 and the separator 191 to transport the first flow 130 to the separator 191. The water separator 191 separates the first flow 130 into the cooling liquid 102 and vapor and directs the vapor to an exhaust 195.

A motor generator 190 is operationally coupled to the turbine 170 and is fluidly coupled to the water separator 191. A shaft 192 may connect the motor generator and the turbine 170. A first portion 102A of the cooling liquid 102 may be directed to the motor generator 190. A sixth conduit 101F may extend between separator 191 and the motor generator 190 to transport the cooling liquid 102 to the motor generator 190. Third waste heat is transferred to the cooling liquid 102 within the motor generator 190.

The cooling liquid 102A may be directed from the motor generator 190 to the first flow 130, between the fuel cell 120 and the first heat exchanger 160. An eighth conduit 101G may extend between motor generator 190 and the second conduit 101B to transport the cooling liquid 102A to the first flow 130 in the second conduit 101B.

A compressor 210 may be coupled to the motor generator 190. The shaft 192 may extend to the compressor 210 via the motor generator 190. It is to be appreciated that shaft segments 192A, 192B, rather than a continuous shaft 192, may be operationally connected via the motor generator 190. The shaft segments 192A, 192B may extend between the motor generator 190 and ones of the turbine 170 and compressor 210.

The compressor 210 may be fluidly coupled to the cooling circuit 101 upstream of the fuel cell 120. The first conduit 101A may extend between the fuel cell 120 and the compressor 210. The compressor 210 may receive the first flow 130, compress the first flow 130 and direct the first flow 130 to the fuel cell 120. As shown in FIG. 1, the compressor 210 may receive the first flow from the cabin 110A of the aircraft 110. The first flow 130 may be directed to the compressor 210 via a cabin exhaust fan 110B.

As shown in FIG. 1, a second portion 102B of the cooling liquid 102 may be directed to the first flow 130, between the compressor 210 and the fuel cell 120. A ninth conduit 101H may extend from the separator 191 to a valve 201 in the first conduit 101A to direct the cooling liquid 102 to the first flow 130. This configuration may be utilized to raise a humidity level of the first flow 130 entering the fuel cell 120 for optimal performance of the fuel cell 120.

As also shown in FIG. 1, the cooling liquid 102 may be directed downstream from the separator 191, e.g., via a further conduit 101J, to the component 105 which may be an electronic system, to the aircraft engine 200 or the ACM 140, as non-limiting examples.

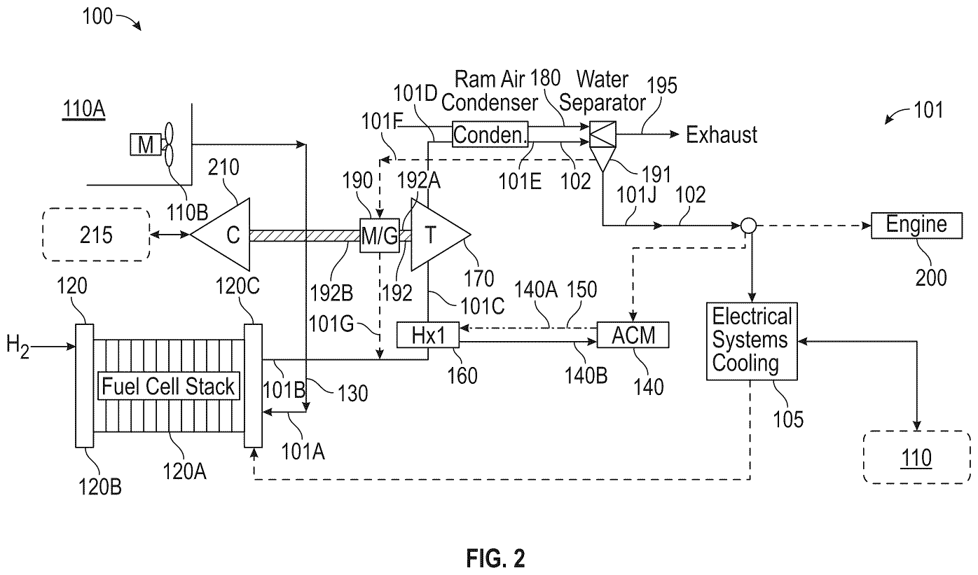

Turning to FIG. 2, another embodiment of the system 100 is disclosed that provides a cooling liquid flow (or for simplicity a cooling liquid) 102 to a component 105 of an aircraft 110, shown schematically.

The system 100 includes a cooling circuit 101. The cooling circuit 101 includes a fuel cell 120. The fuel cell 120 may have a stack 120A of cells, an anode 120B and cathode 120C. The fuel cell 120 receives a first flow 130, which may be air from cabin exhaust, and transfers first waste heat to the first flow 130. A first conduit 101A may direct the first flow 130 to the fuel cell 120 and a second conduit 101B may direct the first flow 130, downstream, from the fuel cell 120.

The system 100 includes an air cycle machine (ACM) 140. The ACM 140 transfers second waste heat to a second flow 150.

A first heat exchanger 160 is fluidly coupled to the cooling circuit 101 and is located downstream of the fuel cell 120. The second conduit 101B may extend between the fuel cell 120 and the first heat exchanger 160 and transport the first flow 130 to the first heat exchanger 160. The first heat exchanger 160 thermally couples the first and second flows 130, 150 to superheat the first flow 130. The first flow 130 may be a relatively hot two phase flow upon exiting the first heat exchanger 160.

The first heat exchanger 160 may be coupled to the ACM 140 via first and second ACM conduits 140A, 140B. The first ACM conduit 140A may transport the second flow 150 to the first heat exchanger 160 and the second ACM conduit 140B may transport the second flow 150 back to the ACM 140.

A turbine 170 is fluidly coupled to the cooling circuit 101 and located downstream of the first heat exchanger 160, and extracts energy from the first flow 130. A third conduit 101C may extend between first heat exchanger 160 and the turbine 170 to transport the first flow 130 to the turbine 170. The turbine 170 may be a flash turbine, which is capable of extracting power from two phase flow. The turbine 170 may alternatively be an impulse turbine, as a non-limiting example.

A condenser 180 is fluidly coupled to the cooling circuit 101 downstream of the turbine 170. The condenser 180 may be a RAM air condenser. A fourth conduit 101D may extend between the turbine 170 and the condenser 180 to transport the first flow 130 to the condenser 180. The condenser 180 condenses the first flow 130 into the cooling liquid 102. The first flow 130 may be a saturated two phase flow upon leaving the condenser 180. As shown in FIG. 2, the component 105 is fluidly coupled to the circuit 101, downstream of the condenser 180. In one embodiment, as shown in FIG. 2, cooling fluid through the component 105, such as electrical systems, is recirculated back to the fuel cell 120.

As further shown in FIG. 2, a water separator 191 is fluidly coupled to the cooling circuit 101 and located between the condenser 180 and the component 105. A fifth conduit 101E may extend between the condenser 180 and the separator 191 to transfer the cooling liquid 102 to the separator 191. The water separator 191 separates the first flow 130 into the cooling liquid 102 and vapor and directs the vapor to an exhaust 195.

A motor generator 190 is operationally coupled to the turbine 170 and is fluidly coupled to the water separator 191. A shaft 192 may connect the motor generator and the turbine 170. A first portion 102A of the cooling liquid 102 may be directed to the motor generator 190. A sixth conduit 101F may extend between separator 191 and the motor generator 190 to transport the cooling liquid 102 to the motor generator 190. Third waste heat is transferred to the cooling liquid 102 within the motor generator 190.

The cooling liquid 102 may be directed from the motor generator 190 to the first flow 130, between the fuel cell 120 and the first heat exchanger 160. An eighth conduit 101G may extend between motor generator 190 and the second conduit 101B to transport the cooling liquid 102 to the first flow 130 in the second conduit 101B.

A compressor 210 may be coupled to the motor generator 190. The shaft 192 may extend to the compressor 210 via the motor generator 190. It is to be appreciated that shaft segments 192A, 192B, rather than a continuous shaft 192, may be operationally connected via the motor generator 190. The shaft segments 192A, 192B may extend between the motor generator 190 and ones of the turbine 170 and compressor 210.

The compressor 210 may be utilized to drive other aircraft systems 215, such an OBIGGS (On-Board Inert Gas Generation System) as one non-limiting example.

As shown in FIG. 2, the fuel cell 120 may receive the first flow from the cabin 110A of the aircraft 110. The first flow 130 may be directed to the compressor 210 via a cabin exhaust fan 110B.

As shown in FIG. 2, the cooling liquid 102 may be directed downstream from the separator 191, e.g., via a further conduit 101J, to the component 105 which may be an electronic system, to the aircraft engine 200 or the ACM 140, as non-limiting examples.

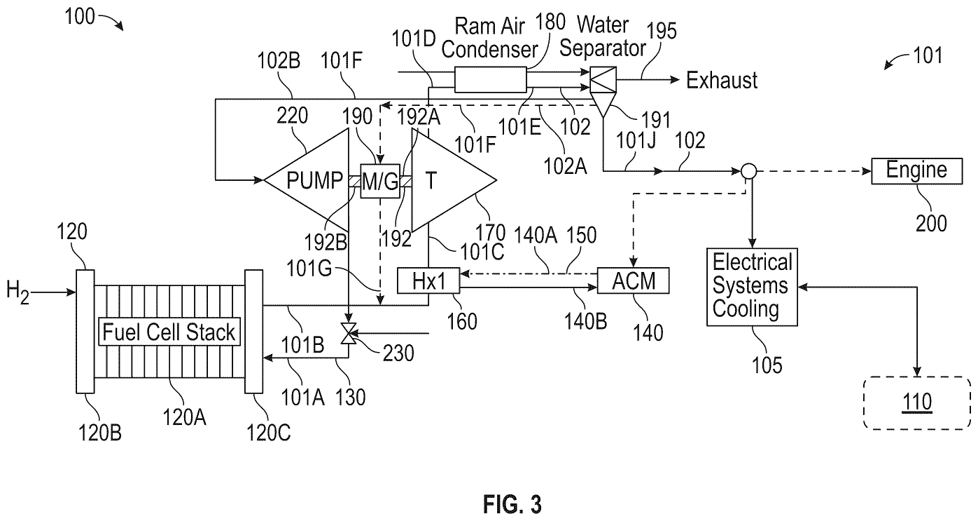

Turning to FIG. 3, another embodiment of a system 100 is disclosed that provides a cooling liquid flow (or for simplicity a cooling liquid) 102 to a component 105 of an aircraft 110, shown schematically.

The system 100 includes a cooling circuit 101. The cooling circuit 101 includes a fuel cell 120. The fuel cell 120 may have a stack 120A of cells, an anode 120B and cathode 120C. The fuel cell 120 receives a first flow 130, which may be water, and transfers first waste heat to the first flow 130. A first conduit 101A may direct the first flow 130 to the fuel cell 120 and a second conduit 101B may direct the first flow 130, downstream, from the fuel cell 120.

The system 100 includes an air cycle machine (ACM) 140. The ACM 140 transfers second waste heat to a second flow 150.

A first heat exchanger 160 is fluidly coupled to the cooling circuit 101 and is located downstream of the fuel cell 120. The second conduit 101B may extend between the fuel cell 120 and the first heat exchanger 160 and transport the first flow 130 to the first heat exchanger 160. The first heat exchanger 160 thermally couples the first and second flows 130, 150 to superheat the first flow 130. The first flow 130 may be a relatively hot two-phase flow upon exiting the first heat exchanger 160.

The first heat exchanger 160 may be coupled to the ACM 140 via first and second ACM conduits 140A, 140B. The first ACM conduit 140A may transport the second flow 150 to the first heat exchanger 160 and the second ACM conduit 140B may transport the second flow 150 back to the ACM 140.

A turbine 170 is fluidly coupled to the cooling circuit 101 and located downstream of the first heat exchanger 160, and extracts energy from the first flow 130. A third conduit 101C may extend between first heat exchanger 160 and the turbine 170 to transport the first flow 130 to the turbine 170. The turbine 170 may be a flash turbine, which is capable of extracting power from two phase flow. The turbine 170 may alternatively be an impulse turbine, as a non-limiting example.

A condenser 180 is fluidly coupled to the cooling circuit 101 downstream of the turbine 170. The condenser 180 may be a RAM air condenser. A fourth conduit 101D may extend between the turbine 170 and the condenser 180 to transport the first flow 130 to the condenser 180. The condenser 180 condenses the first flow 130 into the cooling liquid 102. The first flow 130 may be a saturated two phase flow upon leaving the condenser 180. As shown in FIG. 3, the component 105 is fluidly coupled to the circuit 101, downstream of the condenser 180.

As further shown in FIG. 3, a water separator 191 is fluidly coupled to the cooling circuit 101 and located between the condenser 180 and the component 105. A fifth conduit 101E may extend between the condenser 180 and the separator 191 to transport the first flow 130 to the separator 191. The water separator 191 separates the first flow 130 into the cooling liquid 102 and vapor and directs the vapor to an exhaust 195.

A motor generator 190 is operationally coupled to the turbine 170 and is fluidly coupled to the water separator 191. A shaft 192 may connect the motor generator and the turbine 170. A first portion 102A of the cooling liquid 102 may be directed to the motor generator 190. A sixth conduit 101F may extend between separator 191 and the motor generator 190 to transport the cooling liquid 102 to the motor generator 190. Third waste heat is transferred to the cooling liquid 102 within the motor generator 190.

The cooling liquid 102 may be directed from the motor generator 190 to the first flow 130, between the fuel cell 120 and the first heat exchanger 160. An eighth conduit 101G may extend between motor generator 190 and the second conduit 101B to transport the cooling liquid 102 to the first flow 130 in the second conduit 101B.

A pump 220 may be coupled to the motor generator 190. The shaft 192 may extend to the pump 220 via the motor generator 190. It is to be appreciated that shaft segments 192A, 192B, rather than a continuous shaft 192, may be operationally connected via the motor generator 190. The shaft segments 192A, 192B may extend between the motor generator 190 and ones of the turbine 170 and pump 220.

The pump 220 may and be fluidly coupled to the cooling circuit 101 between the water separator 191 and the fuel cell 120. A second portion 102B of the cooling liquid 102 may be directed to the pump 220. A ninth conduit 101H may extend between the separator 191 and the pump 220 to transport cooling liquid 102 to the pump 220. The first conduit 101A may extend between the fuel cell 120 and the pump 220. An air vent 230 may be fluidly coupled to the cooling circuit 101 between the pump 220 and the fuel cell 120, e.g., to the first conduit 191A. As the pump 220 pumps cooling liquid 102 to the fuel cell 120, air may be introduced to provide a desired air/fluid mixture to the fuel cell 120.

As also shown in FIG. 3, the cooling liquid 102 may be directed downstream from the separator 191, e.g., via a further conduit 101J, to the component 105 which may be an electronic system, to the aircraft engine 200 or the ACM 140, as non-limiting examples.

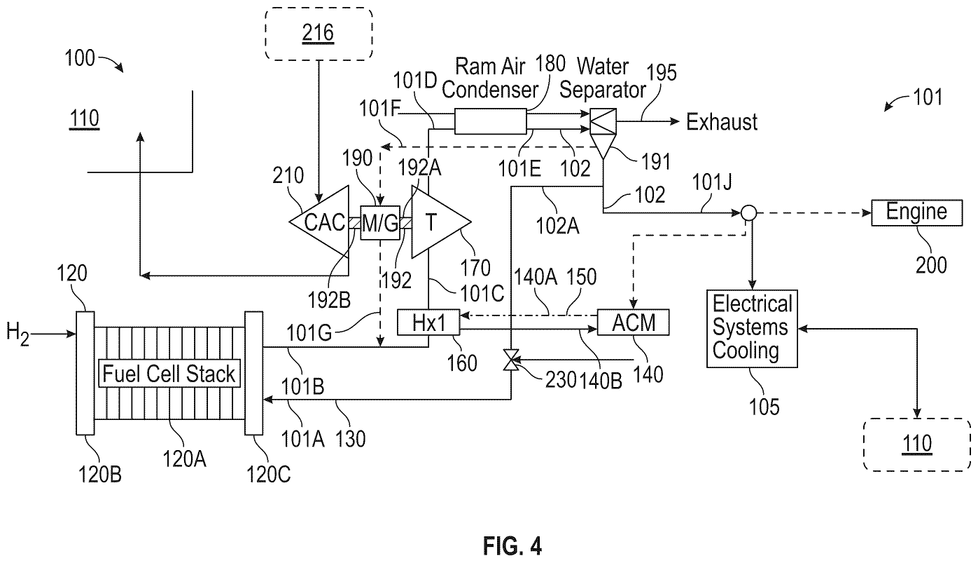

Turning to FIG. 4, another embodiment of a system 100 is disclosed that provides a cooling liquid flow (or for simplicity a cooling liquid) 102 to a component 105 of an aircraft 110, shown schematically.

The system 100 includes a cooling circuit 101. The cooling circuit 101 includes a fuel cell 120. The fuel cell 120 may have a stack 120A of cells, an anode 120B and cathode 120C. The fuel cell 120 receives a first flow 130, which may be water, and transfers first waste heat to the first flow 130. A first conduit 101A may direct the first flow 130 to the fuel cell 120 and a second conduit 101B may direct the first flow 130, downstream, from the fuel cell 120.

The system 100 includes an air cycle machine (ACM) 140. The ACM 140 transfers second waste heat to a second flow 150.

A first heat exchanger 160 is fluidly coupled to the cooling circuit 101 and is located downstream of the fuel cell 120. The second conduit 101B may extend between the fuel cell 120 and the first heat exchanger 160 and transport the first flow 130 to the first heat exchanger 160. The first heat exchanger 160 thermally couples the first and second flows 130, 150 to superheat the first flow 130. The first flow 130 may be a relatively hot two-phase flow upon exiting the first heat exchanger 160.

The first heat exchanger 160 may be coupled to the ACM 140 via first and second ACM conduits 140A, 140B. The first ACM conduit 140A may transport the second flow 150 to the first heat exchanger 160 and the second ACM conduit 140B may transport the second flow 150 back to the ACM 140.

A turbine 170 is fluidly coupled to the cooling circuit 101 and located downstream of the first heat exchanger 160, and extracts energy from the first flow 130. A third conduit 101C may extend between first heat exchanger 160 and the turbine 170 to transport the first flow 130 to the turbine 170. The turbine 170 may be a flash turbine, which is capable of extracting power from two phase flow. The turbine 170 may alternatively be an impulse turbine, as a non-limiting example.

A condenser 180 is fluidly coupled to the cooling circuit 101 downstream of the turbine 170. The condenser 180 may be a RAM air condenser. A fourth conduit 101D may extend between the turbine 170 and the condenser 180 to transport the first flow 130 to the condenser 180. The condenser 180 condenses the first flow 130 into the cooling liquid 102. The first flow 130 may be a relatively cool two-phase flow upon leaving the condenser 180. As shown in FIG. 4, the component 105 is fluidly coupled to the circuit 101, downstream of the condenser 180.

As further shown in FIG. 4, a water separator 191 is fluidly coupled to the cooling circuit 101 and located between the condenser 180 and the component 105. A fifth conduit 101E may extend between the condenser 180 and the separator 191 to transport the first flow 130 to the separator 191. The water separator 191 separates the first flow 130 into the cooling liquid 102 and vapor and directs the vapor to an exhaust 195.

A motor generator 190 is operationally coupled to the turbine 170 and is fluidly coupled to the water separator 191. A shaft 192 may connect the motor generator and the turbine 170. A first portion 102A of the cooling liquid 102 may be directed to the motor generator 190. A sixth conduit 101F may extend between separator 191 and the motor generator 190 to transport the cooling liquid 102 to the motor generator 190. Third waste heat is transferred to the cooling liquid 102 within the motor generator 190.

The cooling liquid 102 may be directed from the motor generator 190 to the first flow 130, between the fuel cell 120 and the first heat exchanger 160. An eighth conduit 101G may extend between motor generator 190 and the second conduit 101B to transport the cooling liquid 102 to the first flow 130 in the second conduit 101B.

A cabin air compressor 210 may be coupled to the motor generator 190. The shaft 192 may extend to the cabin air compressor 210 via the motor generator 190. It is to be appreciated that shaft segments 192A, 192B, rather than a continuous shaft 192, may be operationally connected via the motor generator 190. The shaft segments 192A, 192B may extend between the motor generator 190 and ones of the turbine 170 and compressor 210.

The cabin air compressor 210 may receive air from a source 216, such as RAM air or bleed air, compress the air and direct it to the cabin 110A.

The first conduit 101A may extend to the separator 191 to transport a first portion 102A toward the fuel cell 120. An air vent 230 may be fluidly coupled to the cooling circuit 101 between the separator 191 and the fuel cell 120, e.g., to the first conduit 191A. With the air vent 230, air may be introduced to provide a desired air/fluid mixture to the fuel cell 120.

As also shown in FIG. 4, the cooling liquid 102 may be directed downstream from the separator 191, e.g., via a further conduit 101J, to the component 105 which may be an electronic system, to the aircraft engine 200 or the ACM 140, as non-limiting examples.

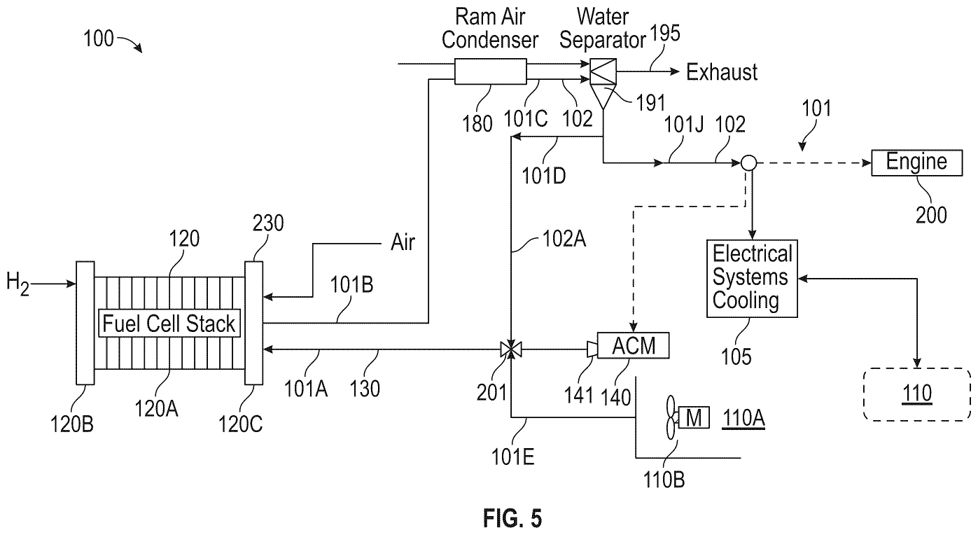

Turning to FIG. 5, another embodiment of a system 100 is disclosed that provides a cooling liquid flow (or for simplicity a cooling liquid) 102 to a component 105 of an aircraft 110, shown schematically.

The system 100 includes a cooling circuit 101. The cooling circuit 101 includes a fuel cell 120. The fuel cell 120 may have a stack 120A of cells, an anode 120B and cathode 120C. The fuel cell 120 receives a first flow 130, which may be water, and transfers first waste heat to the first flow 130. A first conduit 101A may direct the first flow 130 to the fuel cell 120 and a second conduit 101B may direct the first flow 130, downstream, from the fuel cell 120. The fuel cell 120 may have an air vent 230 to provide a desired air/fluid mixture to the fuel cell 120.

A condenser 180 is fluidly coupled to the cooling circuit 101 downstream of the fuel cell 120. The condenser 180 may be a RAM air condenser. The first conduit 101A may extend to the condenser 180 to transport the first flow 130 to the condenser 180. The condenser 180 condenses the first flow 130 into the cooling liquid 102. The first flow 130 may be a saturated two-phase flow upon leaving the condenser 180. As shown in FIG. 5, the component 105 is fluidly coupled to the circuit 101, downstream of the condenser 180.

As further shown in FIG. 5, a water separator 191 is fluidly coupled to the cooling circuit 101 and located between the condenser 180 and the component 105. A third conduit 101C may extend between the condenser 180 and the separator 191 to transport the first flow 130 to the separator 191. The water separator 191 separates the first flow 130 into the cooling liquid 102 and vapor and directs the vapor to an exhaust 195.

An air cycle machine (ACM) 140 may be fluidly coupled to the cooling circuit 101 upstream of the fuel cell 120, which directs the first flow 130 to the fuel cell 120. The ACM 140 may have an ACM turbine 141 and the first conduit 101A may extend between the ACM turbine 141 and the fuel cell 120 to direct the first flow 130, produced by the ACM turbine 141, to the fuel cell 120.

A valve 201 may be in the first conduit 101A, between the ACM 140 and the fuel cell 120. A first portion 102A of the cooling liquid 102 may be directed to the first flow 130, between the ACM 140 and the fuel cell 120. A fourth conduit 101D may extend from the separator 191 to the valve 201 to direct the cooling liquid 102 to the first flow 130 within the first conduit 101A. Additionally, cabin air from the cabin 110A may be directed to the first flow 130, between the ACM 140 and the fuel cell 120. A fifth conduit 101E may extend from the cabin 110A to the valve 201 to direct the cabin air, urged by a cabin exhaust fan 110B to the first flow 130 within the first conduit 101A. With this configuration, humidity and characteristics of the flow to the fuel cell 120 may be preferentially controlled.

As also shown in FIG. 5, the cooling liquid 102 may be directed downstream from the separator 191, e.g., via a further conduit 101J, to the component 105 which may be an electronic system, to the aircraft engine 200 or the ACM 140, as non-limiting examples.

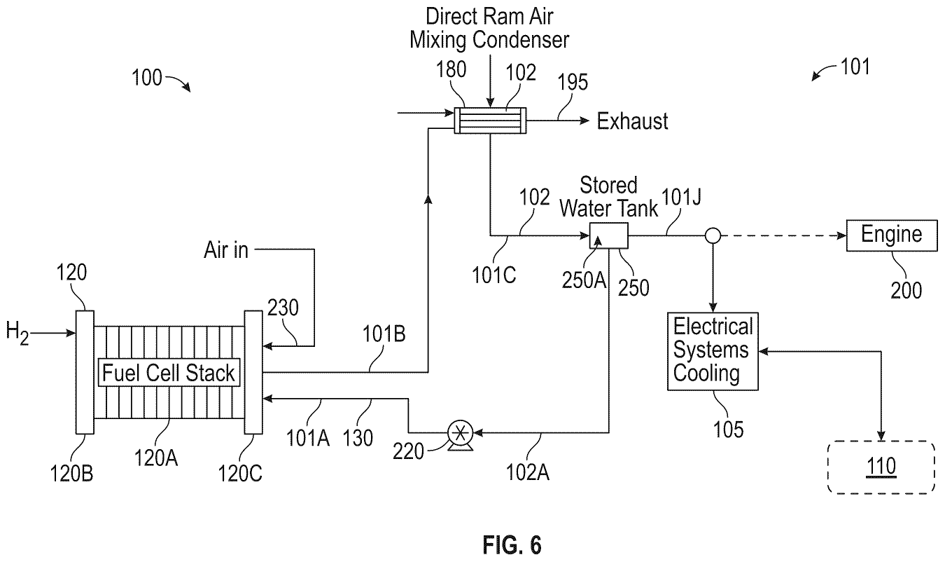

Turning to FIG. 6, another embodiment of a system 100 is disclosed that provides a cooling liquid flow (or for simplicity a cooling liquid) 102 to a component 105 of an aircraft 110, shown schematically.

The system 100 includes a cooling circuit 101. The cooling circuit 101 includes a fuel cell 120. The fuel cell 120 may have a stack 120A of cells, an anode 120B and cathode 120C. The fuel cell 120 receives a first flow 130, which may be water, and transfers first waste heat to the first flow 130. A first conduit 101A may direct the first flow 130 to the fuel cell 120 and a second conduit 101B may direct the first flow 130, downstream, from the fuel cell 120.

A condenser 180 is fluidly coupled to the cooling circuit 101 downstream of the fuel cell 120. The condenser 180 may be a RAM air condenser. The first conduit 101A may extend to the condenser 180 to transport the first flow 130 to the condenser 180. The condenser 180 condenses the first flow 130 into the cooling liquid 102 and may direct vapor to an exhaust 195. The first flow 130 may be a relatively cool two phase flow upon leaving the condenser 180. As shown in FIG. 6, the component 105 is fluidly coupled to the circuit 101, downstream of the condenser 180.

A pump 220 may be fluidly coupled to the cooling circuit 101 between the condenser 180 and the fuel cell 120 to direct a first portion 102A of the cooling liquid 102 to the fuel cell 120 as the first flow 130. A third conduit 101C may extend between the condenser 180 and the pump 220 to transport cooling fluid 102 to the pump 220. The first conduit 101A may extend from the pump 220 to the fuel cell 120 to transport the cooling fluid 102 as the first flow 130 to the fuel cell 120. A fluid storage tank 250 may be fluidly coupled to the cooling circuit 101 between the condenser 180 and the pump 220, i.e., along the third conduit 101C. The storage tank 250 may provide supplemental fluid for the first flow 130. The fuel cell 120 may have an air vent 230 to provide a desired air/fluid mixture to the fuel cell 120.

As also shown in FIG. 6, the cooling liquid 102 may be directed downstream from the condenser 180, e.g., via a further conduit 101J, to the component 105 which may be an electronic system, or to the aircraft engine 200, as non-limiting examples.

With the above embodiments, by combining fuel cell and ACM cycles and using two-phase impulse turbines, it is possible to increase efficiency of the cycles. The utilization of condensed water may allow the elimination of RAM air for ACM cooling. That is, though RAM air may be utilized for the disclosed condensers, avoiding the need to use RAM air for cooling the ACM results in a net increase in operational efficiencies.

The embodiments provide for significant increase in fuel cell energy recuperation. The embodiments also provide the ability to capture and utilize ACM thermal energy. The embodiments provide the ability to integrated an ACM and a fuel cell to provide for cooling of electrical systems. The embodiments further provide the ability to operate without a RAM heat exchanger for the ACM, reducing aircraft drag and weight. The embodiments provide a cooling system with a relatively small overall weight and size as compared with systems that utilize a RAM air heat exchanger for cooling the ACM. The minimal use of the RAM air in the embodiments may enable the integration of a RAM air heat exchanger in the skin of an aircraft.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A system that provides a cooling liquid to a component of an aircraft, the system comprising:
a cooling circuit that includes a fuel cell that receives a first flow and transfers first waste heat to the first flow;
an air cycle machine (ACM) that transfers second waste heat to a second flow;
a first heat exchanger, fluidly coupled to the cooling circuit downstream of the fuel cell, that thermally couples the first and second flows to superheat the first flow;
a turbine, fluidly coupled to the cooling circuit downstream of the first heat exchanger, that extracts energy from the first flow; and
a condenser, fluidly coupled to the cooling circuit downstream of the turbine, that condenses the first flow into the cooling liquid,
wherein the component is fluidly coupled to the circuit downstream of the condenser.

2. The system of claim 1, wherein the condenser is a RAM air condenser.

3. The system of claim 1, wherein the turbine is a flash turbine or an impulse turbine.

4. The system of claim 1, further comprising
a water separator, fluidly coupled to the cooling circuit between the condenser and the component, that separates the first flow into the cooling liquid and vapor and directs the vapor to an exhaust.

5. The system of claim 4, further comprising
a motor generator, operationally coupled to the turbine, and fluidly coupled to the water separator,
wherein:
a first portion of the cooling liquid is directed to the motor generator, and third waste heat is transferred to the cooling liquid within the motor generator; and
the cooling liquid is directed from the motor generator to the first flow, between the fuel cell and the first heat exchanger.

6. The system of claim 5, further comprising
a compressor, coupled to the motor generator.

7. The system of claim 6, wherein:
the compressor is fluidly coupled to the cooling circuit upstream of the fuel cell; and
the compressor receives the first flow, compresses the first flow and directs the first flow to the fuel cell.

8. The system of claim 7, wherein
a second portion of the cooling liquid is directed to the first flow, between the compressor and the fuel cell, to thereby raise a humidity level of the first flow entering the fuel cell.

9. The system of claim 5, further comprising
a pump, coupled to the motor generator and fluidly coupled to the cooling circuit between the water separator and the fuel cell, wherein a second portion of the cooling liquid is directed to the pump.

10. The system of claim 9, further comprising
an air vent fluidly coupled to the cooling circuit between the pump and the fuel cell.

11. The system of claim 5, further comprising
a cabin air compressor, coupled to the motor generator.

12. A system that provides a cooling liquid to a component of an aircraft, the system comprising:
a cooling circuit that includes a fuel cell that receives a first flow and transfers first waste heat to the first flow;
a condenser, fluidly coupled to the cooling circuit downstream of the fuel cell, that condenses the first flow into the cooling liquid,
wherein the component is fluidly coupled to the circuit downstream of the condenser.

13. The system of claim 12, further comprising
a water separator, fluidly coupled to the cooling circuit between the condenser and the component, that separates the first flow into the cooling liquid and vapor and directs the vapor to an exhaust.

14. The system of claim 13, further comprising
an air cycle machine, fluidly coupled to the cooling circuit upstream of the fuel cell that directs the first flow to the fuel cell.

15. The system of claim 14, wherein
a first portion of the cooling liquid is directed to the first flow, between the ACM and the fuel cell, to thereby raise a humidity level of the first flow entering the fuel cell.

16. The system of claim 12, further comprising
a pump, fluidly coupled to the cooling circuit between the condenser and the fuel cell, and a fluid storage tank fluidly coupled to the cooling circuit between the condenser and the pump,
wherein the first flow includes a first portion of the cooling liquid and fluid from the storage tank that are pumped to the fuel cell via the pump.

17. A system that generates power for an aircraft, the system comprising:
a first circuit that includes a fuel cell that receives a first flow and transfers first waste heat to the first flow;
an air cycle machine that transfers second waste heat to a second flow;
a first heat exchanger, fluidly coupled to the first circuit downstream of the fuel cell, that thermally couples the first and second flows to superheat the first flow;
a first pump, fluidly coupled to the first circuit downstream of the first heat exchanger, to pump the first flow through the first circuit; and
a second circuit that is a cogeneration refrigeration (CR) circuit with a third flow flowing through the second circuit, and the second circuit includes a second heat exchanger that is thermally coupled to the first heat exchanger to transfer heat energy to the third flow, thereby cooling the first flow.

18. The system of claim 17, wherein
the cogeneration refrigeration circuit includes:
a refrigeration loop and a power generation loop coupled to each other via a divider and a mixer,
wherein:
the refrigeration loop includes a first branch extending between an inlet of the divider and an outlet of the mixer, and a second branch extending between a first outlet of the divider and a first inlet of the mixer;
the first branch includes an evaporator, a compressor, and a condenser, a second pump, and the second heat exchanger, and the second branch includes an expansion valve; and
the power generation loop extends from a second outlet of the divider and a second inlet of the mixer,
wherein the power generation loop includes at least one turbine.

19. The system of claim 18, wherein:
the power generation loop includes a second turbine downstream of the first turbine; and
a first control valve upstream of the first turbine and an isolation valve downstream of the second turbine.

20. The system of claim 17, wherein
the first circuit includes a humidifier fluidly coupled to the fuel cell to control a humidity level within the fuel cell.
